(19) United States
(12) Patent Application Publication
(10) Pub. No.: US 2016/0070327 A1
(43) Pub. Date: Mar. 10, 2016

(54) SYSTEM AND METHOD FOR PEAK CURRENT MANAGEMENT TO A SYSTEM ON A CHIP

(71) Applicant: QUALCOMM INCORPORATED, San Diego, CA (US)

(72) Inventors: MAHADEVAMURTY NEMANI, SAN DIEGO, CA (US); JEFFREY RUNNER, SAN DIEGO, CA (US); NILANJAN BANERJEE, SAN DIEGO, CA (US)

(21) Appl. No.: 14/480,511

(22) Filed: Sep. 8, 2014

(51) Int. Cl. G06F 1/32; G06F 1/20

(52) U.S. Cl. CPC G06F 1/3206; G06F 1/3234; G06F 1/206

(57) ABSTRACT

Various embodiments of methods and systems for managing current consumption in a portable computing device (“PCD”) are disclosed. A duration of time associated with a maximum allowable current consumption through a voltage regulator is divided into a plurality of N sub-durations. The current consumption for each sub-duration is monitored and a moving sum of current consumption is calculated for a plurality of past sub-durations. Using the sum of current consumption, a current budget for a next sub-duration or next set of consecutive sub-durations may be determined. Subsequently, throttling levels of power consuming processing components may be adjusted such that a maximum allowable current consumption over consecutive N sub-durations may be maintained beneath a peak current threshold without unnecessarily sacrificing processing capacity of the processing components.

### DESCRIPTION OF THE RELATED ART

Portable computing devices (“PCDs”) are powerful devices that are becoming necessities for people on personal and professional levels. Examples of PCDs may include cellular telephones, portable digital assistants (“PDAs”), portable game consoles, palmtop computers, and other portable electronic devices.

As users have become more and more reliant on PCDs, demand has increased for more and better functionality. Simultaneously, users have also expected that the quality of service (“QoS”) and overall user experience not suffer due to the addition of more and better functionality.

Generally, providing more and better functionality in a PCD drives designers to use larger, more robust power management integrated circuits (“PMIC”) and/or larger batteries capable of delivering more mA-Hr of battery capacity. Batteries and PMICs may be sized for “worst case” scenarios of power consumption in the PCD. However, the trend in PCD design is for smaller form factors that often preclude the inclusion of a larger battery or more robust PMIC. Moreover, because the mA-Hr density of available battery technology has stagnated, the inclusion of a higher power density battery in a given size is no longer the answer to support the additional functionality. Rather, to accommodate the additional functionality in today's PCDs, without oversizing the PMIC and battery, the limited amount of available power supply must be managed such that it is leveraged efficiently and user experience is optimized.

Power consuming components on a typical SoC, such as processing components, draw power from a power rail that is supplied by a PMIC and regulated by a voltage regulator. If the processing components request an increase in power supply that causes a current threshold for the voltage regulator to be exceeded, then actions must be taken to avoid exceeding the current threshold. For example, the workload and/or the clock frequency setting of one or more processing components may be reduced in an effort to bring the current of the power supply down to a suitable level to avoid performance degradation and/or outright device failure. Therefore, there is a need in the art for a system and method that optimizes a peak current budget supplied to a SoC from a PMIC. More specifically, there is a need in the art for a system and method that manages a current supply from a PMIC such that user experience is optimized without exceeding a peak current threshold.

### SUMMARY OF THE DISCLOSURE

Various embodiments of methods and systems for managing current consumption in a portable computing device (“PCD”) or its equivalent are disclosed. An exemplary method for managing current consumption in a PCD comprises dividing a duration of time associated with a maximum allowable current consumption through a voltage regulator into a plurality of N sub-durations. The current consumption for each sub-duration is monitored and a moving sum of current consumption is calculated for a plurality of past sub-durations. Using the sum of current consumption, the method may determine a current budget for a next sub-duration or next set of consecutive sub-durations. Subsequently, throttling levels of power consuming processing components may be adjusted such that a maximum allowable current consumption over consecutive N sub-durations may be maintained beneath a peak current threshold without unnecessarily sacrificing processing capacity of the processing components. Throttling levels may be adjusted in some embodiments based on active dynamic current consumption levels of processing components deduced from operating temperatures of the processing components.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a graph illustrating the relationship between an exemplary current budget and an exemplary active current input to a voltage regulator for a system on a chip (“SoC”) utilizing a budget-based peak current management methodology;

FIG. 2 is a functional block diagram illustrating an exemplary embodiment of a system for peak current management to a system on a chip (“SoC”) in a portable computing device (“PCD”);

FIG. 3 is a functional block diagram of an exemplary, non-limiting aspect of a PCD in the form of a wireless telephone for implementing methods and systems for peak current management;

FIG. 4 is a schematic diagram illustrating an exemplary software architecture of the PCD of FIG. 3 for supporting active current monitoring and application of algorithms associated with peak current management techniques;

FIG. 5 is a logical flowchart illustrating a method for budget-based peak current management in a PCD;

FIG. 6 is a logical flowchart illustrating a method for temperature aware budget-based peak current management in a PCD;

FIG. 7 is a logical flowchart illustrating a method for proportional, integral and derivative (“PID”) based peak current management in a PCD; and

FIG. 8 is a logical flowchart illustrating a method for temperature aware proportional, integral and derivative (“PID”) based peak current management in a PCD.

### DETAILED DESCRIPTION

The word “exemplary” is used herein to mean serving as an example, instance, or illustration. Any aspect described herein as “exemplary” is not necessarily to be construed as exclusive, preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system,” “processing component” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “central processing unit (“CPU”),” “digital signal processor (“DSP”),” and “chip” are used interchangeably. Moreover, a CPU, DSP, or a chip may be comprised of one or more distinct processing components generally referred to herein as “core(s).”

In this description, the term “call” refers to a request for additional resources and/or functionality in a PCD over and above that which may be running at the time of the call. As such, one of ordinary skill in the art will understand that a call may be the result of a PCD user requesting the PCD to perform some function, provide some service, generate and render some deliverable or the like. Moreover, one of ordinary skill in the art will also understand that a call for a PCD resource may be the result of a given component within the PCD leveraging another component within the PCD to complete a workload task. As a non-limiting example, a user action to open a browser application on a PCD may cause calls for additional resources/components in the PCD not in use at the time of the call such as a modem, a graphical processor and/or a display. One of ordinary skill in the art will understand that allowing a call for a component or resource may increase a current level for power supplied from a PMIC within a PCD.

In this description, the terms “workload,” “process load” and “process workload” are used interchangeably and generally directed toward the processing burden, or percentage of processing burden, associated with a given processing component in a given embodiment. Further to that which is defined above, a “processing component” may be, but is not limited to, a central processing unit, a graphical processing unit, a core, a main core, a sub-core, a processing area, a hardware engine, etc. or any component residing within, or external to, an integrated circuit within a portable computing device.

In this description, the term “peak current management,” “current management” and the like generally refer to measures and/or techniques for optimizing the use of power supplied from a PMIC and to a SoC via a voltage regulator. It is an advantage of various embodiments that the current supply may be managed by peak current management techniques to optimize user experience and provide higher levels of quality of service without violating a peak current threshold associated with a voltage regulator. Moreover, one of ordinary skill in the art will understand that the term “demand,” as used in this description envisions the quantification of any current load from a PMIC that can be measured and monitored via one or more current sensors and related components.

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop computer with a wireless connection, a notebook computer, an ultrabook computer, a tablet personal computer (“PC”), among others. Notably, however, even though exemplary embodiments of the solutions are described herein within the context of a PCD, the scope of the solutions are not limited to application in PCDs as they are defined above. For instance, it is envisioned that certain embodiments of the solutions may be suited for use in automotive applications. For an automotive-based implementation of a solution envisioned by this description, the automobile may be considered the “PCD” for that particular embodiment, as one of ordinary skill in the art would recognize. As such, the scope of the solutions is not limited in applicability to PCDs per se.

Exemplary methods and systems generally referred to herein as including peak current management (“PCM”) module(s) seek to monitor, analyze and manage a power demand in a PCD as may be indicated by a current level associated with a power supply through a voltage regulator. A PCM module, perhaps in conjunction with a monitoring module, seeks to monitor and manage a current level in view of a peak current budget in an effort to optimize power usage by processing components on a SoC. A PCM module may also work with a DCVS system to modify a clock frequency or voltage level to one or more processing components such that an overall current demand is adjusted and the peak current level maintained within a current budget. It is envisioned that in certain embodiments a PCM module may determine an input to a DCVS module based partly on operating temperatures of processing components controlled by the DCVS module.

Certain systems for peak current management may employ a “lookahead” budget-based methodology while other embodiments may employ a proportional, integral and derivative (“PID”) methodology. A lookahead budget-based peak current management methodology adjusts a current budget ceiling for a next sub-duration of a time window (or a next group of sub-durations of a time window) based on current consumption over a number of previous sub-durations, thereby ensuring that a peak current threshold is not exceeded. A PID peak current management methodology may adjust inputs to processing components based on a current consumption over a number of previous sub-durations, thereby affecting the overall current consumption and ensuring that a peak current threshold is not exceeded. Notably, it is also envisioned that certain lookahead budget-based peak current management methodologies and PID peak current management methodologies may consider operating temperatures (and, by extension, dynamic current and leakage current levels) of processing components when issuing instructions to adjust power consumption.

### Lookahead Budget-based Peak Current Management Methodologies

PMIC peak current management requires ensuring that the current consumption on a SoC powered by the PMIC, over a defined time window “T” (˜1 microsecond, for example), does not exceed the rated maximum current for a voltage regulator. The maximum current constraint may be measured and held over any window of duration T. Given the very short time window over which the maximum current constraint may be enforced, management of the current level to the voltage regulator dictates that either the instruction issue rate (i.e., workload scheduling) or the clock frequency to one or more processing components on the SoC be controlled. Notably, the better algorithms for managing power consumption on a SoC may minimize performance degradation of the processing components while avoiding significant di/dt events (i.e., events with a significant change in current consumption over a relatively short time window).

Advantageously, embodiments of a solution for peak current management (“PCM”) consider the current consumed over “(N−1) sub-durations” of a time window comprised of N sub-durations in order to calculate the current consumption budget for the next sub-duration (Nth sub-duration). Certain PCM embodiments may also manage the di/dt by controlling throttling levels of power consuming processing components on the SoC, thereby mitigating the severity of any di/dt events. It is envisioned that certain PCM algorithms may calculate the “lookahead” computation for the current budget of more than one future sub-duration.

PCM embodiments that manage current levels from a PMIC to a voltage regulator may measure and monitor the current consumed by one or more processing components on the SoC. Based on the current measurements, PCM embodiments may apply a control output with a relatively small latency so as to avoid performance/stability issues in the PCD that may unnecessarily impact the quality of service (“QoS”) experience by a user. Moreover, PCM embodiments may avoid significant changes to the performance levels of processing components on the SoC so as to manage the introduction of power supply noise (for example, as may occur when adjusting from a state of severe clock throttling to a state where the clock is not throttled at all, thereby causing a steep increase in current consumption over a relatively short time window).

Advantageously, PCM embodiments may be predictive, and therefore proactive, in managing current consumption within a PCD. Based on an immediate history of current consumption over sub-durations of a time window “T”, PCM embodiments may calculate an allowable current budget for subsequent sub-durations within the time window T such that a threshold for the peak current consumption over the window is not violated. Exemplary PCM embodiments are described below for cases where the lookahead is for one sub-duration as well as cases where the lookahead is for two sub-durations and, by extension, “K” sub-durations. Moreover, the exemplary embodiment offered below is described within the context of clock throttling, although it is envisioned that PCM embodiments may generate outputs for adjusting workload scheduling. As such, for the example offered below, the output of the PCM algorithm may be expressed by [M, N], where M is the number of clock cycles to be preserved over a N cycle window.

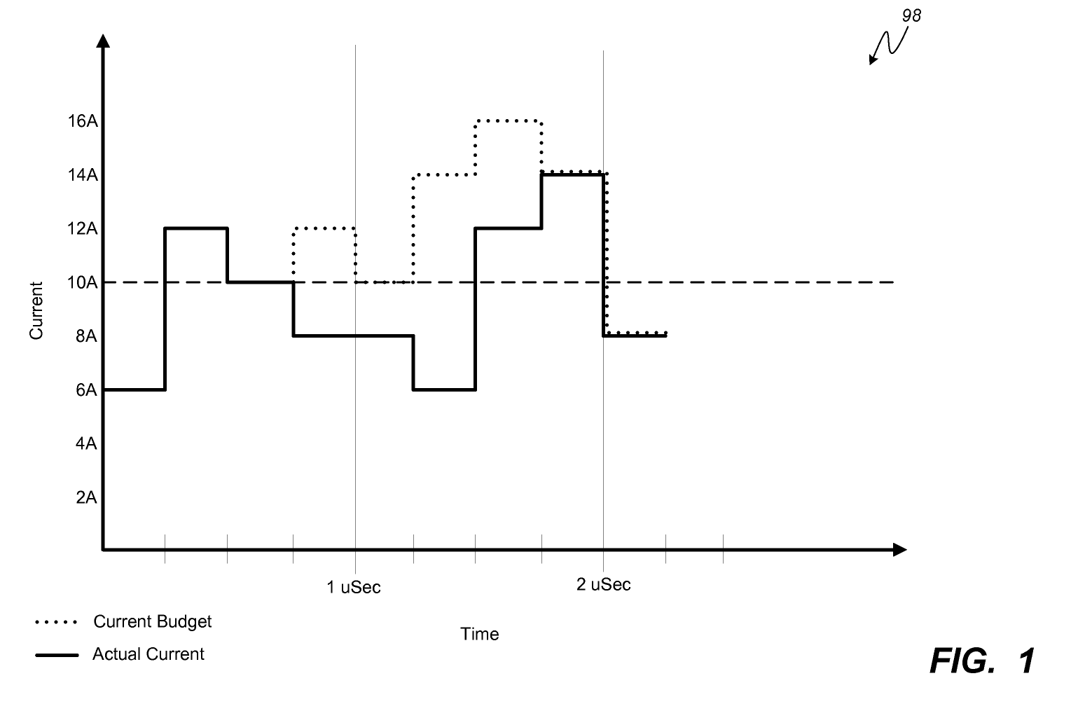

FIG. 1 is a graph 98 illustrating the relationship between an exemplary current budget (represented by the dotted line) and an exemplary active current input (represented by the solid line) to a voltage regulator for a system on a chip (“SoC”) utilizing a budget-based peak current management (“PCM”) methodology. For illustrative purposes, it may be assumed that the exemplary PCM system associated with the graph 98 employs a current sensor and monitoring system that provides data at 4 MS/sec, the MAX PMIC current limit over any single microsecond (“usec”) window is ten amps (“10 A”) and the peak un-throttled current on the power rail supplying the SoC is 16 A.

In the FIG. 1 example, any one (“1”) usec window is divided into four (“4”) sub-durations or “slots.” Although the FIG. 1 example is described relative to a 1 usec time window divided into four sub-durations, PCM embodiments are not limited to application over 1 usec time windows divided into four sub-durations; i.e., it is envisioned that PCM embodiments may consider current consumption over any time window and may do so by monitoring and measuring current consumption over any number of sub-durations of a given time window.

Returning to the FIG. 1 graph 98, the current consumed over the most recent three slots by the processing components residing on the SoC may be available from a current sensor. Using the current consumed over the most recent three slots and the peak current allowed over the 1 usec window, the exemplary PCM embodiment computes a remaining budget for the next slot (i.e., the 4^{th} slot in the FIG. 1 example). Notably, and as one of ordinary skill in the art would recognize, so long as the current consumed over the last slot does not exceed the calculated current budget for that slot, the peak current allowed over the given 1 usec window will not be violated. In this way, the exemplary PCM embodiment uses a moving calculation of the most recent three sub-durations to calculate a current budget for the next sub-duration or sub-durations. By doing so, it is an advantage of PCM embodiments that a maximum remaining current budget is allocated to the next slot, thereby optimizing performance during the slot by taking advantage of the current savings from the previous slots. If more current budget is available for a next slot than would otherwise be needed during that slot to support processing components at a current throttling level, the PCM embodiment may drive a reduction in the amount of throttling. Similarly, if the current budget available for a next slot is less than may be needed to maintain processing components on the SoC at a certain throttle level, the PCM embodiment may dictate an increase in throttling to avoid a peak current threshold over the 1 usec time window from being exceeded.

An exemplary PCM algorithm consistent with the FIG. 1 graph 98 may be summarized as follows:

I_{—}B(k)=K*I_LIM−SI_{—}i(I=0,1,2, . . . ,K−1)

[The budget for the Kth slot may be computed by this equation]

I_MAX(k)=MIN(#Active*I_MAXLLM+#Ret*I_LEAK,I_(k−1)+DI)

(Maximum load increase expected in K)[The maximum current expected in the Kth slot may be computed]

DI=#Active*[I_{—}D*M(k−1)/N+I_(k−1)*DM/N]:DM/N=a

[The maximum di/dt expected in the Kth step may be computed; In any sub-duration or slot the change in throttling amount may be limited by some embodiments such that a resulting increase in current is also limited. Thus DM in the above equation may be a configurable parameter in some PCM embodiments]

This is the maximum expected di/dt in step K, relative to step (K−1)

1^{st} term is the dynamic current increase due to C_DYN change

2^{nd} term is the dynamic current increase due to change in pulse swallowing ratio (due to reduction in throttling). It is envisioned that a reduction in throttling may not be permitted by some PCM embodiments to be faster than DM, thus reducing di/dt at the cost of performance.

If (I_B(k)>=I_MAX(k))

[M,N](k)←MIN(1,[M,N](k−1)+D[M,N]);

(if the available budget is more than the maximum expected current, throttling may be reduced)

Else [M,N](k)←LUT(I_{—}B(k));

(if budget is less than expected maximum current, a new throttling amount may be estimated from a look-up table)

### Where:

I_LIM=PMIC max current limit per usec (may be programmed value)

I_MAXLIM=Maximum current seen by an active core for a given V, F, T, Skew (may be programmed value)

I_LEAK=Maximum current seen by a core in retention for a given V, T, Skew; (may be programmed value)

I_D=Max current step seen on the core for a given (V, F); (may be programmed value)

#Active=Number of active cores (i.e., number of active processing components residing on the SoC and consuming power)

#Ret=Number of cores in retention (i.e., number of total processing components on SoC-#Active)

D[M, N]=Maximum increase in ratio allowed per time step (may be programmed value)

K=Number of samples per usec.

I_B=Current budget

I_MAX=Maximum current expected

[M, N]=permissible amount M of clock pulses in N clock pulses.

Notably, it is envisioned that certain PCM embodiments may leverage a multi-cycle lookahead, as opposed to a single slot lookahead such as that described by the above PCM algorithm. Building on the equations above, an exemplary PCM embodiment employing a two slot lookahead may:

In addition to I_B(K), compute I_B(K+1), where

I_{—}B(K+1)=K*I_LIM−(I_{—}B(K)SI_{—}i)(I=1,2, . . . ,K−1)

IF(MIN(I_{—}B(K),I_{—}B(K+1))>I_MAX(K))

[M,N](K)←MIN(1,[M,N](K−1)+D[M,N]);

(throttling may be reduced only if there is enough budget for the next two slots)

Else[M,N](k)←LUT(MIN(I_{—}B(K),I_{—}B(K+1)));

(the limiting budget may be used to determine the amount of throttling)

### PID Peak Current Methodologies

Certain PCM embodiments, whether budget-based or PID based, may leverage knowledge of operating temperatures associated with the processing components on the SoC to determine an appropriate output for managing the peak current. An exemplary PID-based PCM solution may be illustrated through the following example. Consider a processing component residing on a SoC that at temperature T_1 consumes 12 A of current, 10 A of which is attributable to dynamic current and 2 A of which is attributable to leakage current. Further, assume that the same processing component at a higher temperature T_2 consumes 7 A of dynamic current (at a different voltage and frequency) and 5 A of leakage current. In both cases, a PCM system may determine that the current consumption should be lowered by 2 A in order to keep peak current levels within a 10 A PMIC budget. However, if the PCM algorithm does not compensate for temperature, the degree of throttling may be dictated by the amount of throttling required at T_2 (which corresponds to a throttling amount of ˜30%), thereby adversely affecting performance at T_1 (where the throttling amount required is only 20%). As such, it is envisioned that certain PCM solutions may compensate outputs based on operating temperatures of the processing components.

An exemplary PCM solution that considers operating temperatures is offered below for illustrative purposes and is motivated for a PID based methodology, though the same concept may be applied to budget based algorithms as well. A PID based PCM methodology may work as follows. Consider the following current measurements at time “K”: I(K), I(K−1), I(K−2) and I(K−3) (assumes a history of 4). A filtered version of this current C=P*I(K)+I*(I(K)+I(K−1)+I(K−2)+I(K−3))+D*(I(K)−I(K−1)). As would be understood by one of ordinary skill in the art of closed loop control, P, I & D are proportional, Integral and Derivative coefficients. The PCM method may then compare “C” with a limit “L”. If L<C, throttling of processing components may be engaged, otherwise throttling is not engaged.

Using knowledge of the operating temperature(s) of the processing component(s), the exemplary PID based determination of an output to control the peak current over a time window composed of sub-durations may be modified as follows. Notably, because the expected temperature variation over a given time window may be less than 2-3 Celsius, it is envisioned that the change in leakage current over the same time window may be small. Because a baseline leakage of a given processing component may be known, it is envisioned that PCM embodiments may compute the portion of current consumption attributable to leakage current when an operating temperature is known.

With knowledge of operating temperature, a PCM solution may modify the limit to L′=L−(P*Leakage+4*I*Leakage). With the new limit L′:
I′(K)=I(K)−Leakage;
I′(K−1)=I(K−1)−Leakage;
I′(K−2)=I(K−2)−Leakage; and
I′(K−3)=I(K−3)−Leakage;

Consequently, C′=P*I′(K)+I*(I′(K)+I′(K−1)+I′(K−2)+I′(K−3))+D*(I′(K)−I′(K−1)). The exemplary PCM solution then compares L′ with C′. If C′>L′ throttling may be engaged. Advantageously, because the exemplary PCM solution targets dynamic currents, the amount of throttling required to maintain peak current consumption below a threshold may be sensitized to a desired magnitude of reduction in dynamic current. Thus, returning to the above example, the exemplary PCM solution may recognize that for the 1^{st} case the dynamic current may need to be reduced from 10 A to 8 A and thus, issue instructions to throttle by 20%. Similarly, the PCD solution may recognize in the 2^{nd} case the dynamic current may need to be reduced from 7 A to 5 A and thus, issue instructions to throttle by 30%.

Advantageously, a PCM solution that considers operating temperature(s) of processing component(s) may not require separate characterization and programming for different process bins, as the components affected by process variation are discounted before determination of a throttling response.

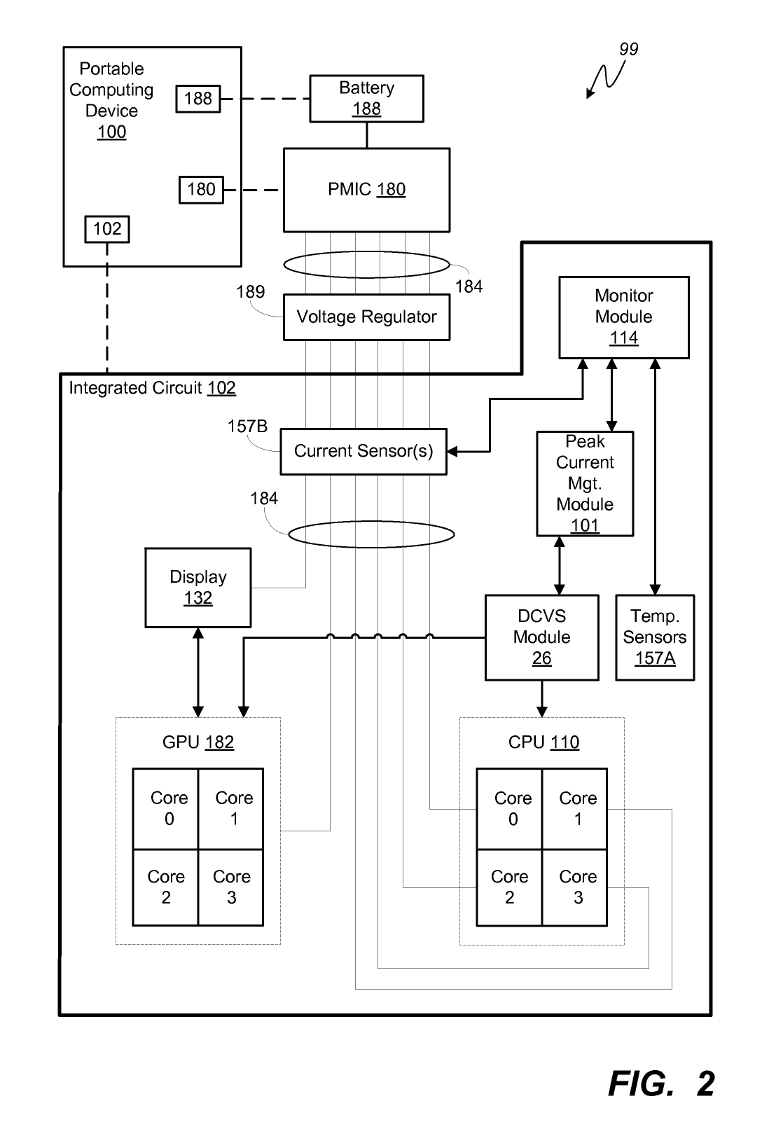

FIG. 2 is a functional block diagram illustrating an exemplary embodiment of a system 99 for peak current management to a system on a chip (“SoC”) 102 in a portable computing device (“PCD”) 100. The PCM module 101 may leverage knowledge of current consumption over recent sub-durations into a voltage regulator 189 to determine a current budget for a next sub-duration and direct a DCVS module 26 to adjust power consumption levels of one or more processing components (such as GPU 182 and CPU 110). Consequently, the quality of service (“QoS”) experienced by the user of a PCD 100 may be optimized as current consumption over a certain time window (comprised of multiple sub-durations, previous and future) is maintained beneath a peak current threshold.

As can be seen in the exemplary illustration of FIG. 2, a power management integrated circuit (“PMIC”) 180 is configured to supply power to each of one or more exemplary processing components 110, 132, 182 residing within the integrated circuit 102. As depicted, the power is sourced from the battery 188 and distributed by the PMIC 180 to each of the processing components 110, 132 182 through a voltage regulator 189 and via a number of dedicated power rails 184. Notably, in the FIG. 2 illustration, display 132 and graphical processing unit (“GPU”) 182 are each depicted as having a single, associated power supply rail 184 while each of cores 0, 1, 2 and 3 of central processing unit (“CPU”) 110 are depicted as having a dedicated power rail 184. Even so, one of ordinary skill in the art will recognize that any core, sub-core, sub-unit or the like within a processing component, such as components 110, 132 182, may share a common power rail with complimentary components or have a dedicated power rail 184 and, as such, the particular architecture illustrated in FIG. 2 is exemplary in nature and will not limit the scope of the disclosure.

Returning to the FIG. 2 illustration, one or more current sensors 157B are configured to monitor power rails 184 and generate a signal indicative of current consumption by the particular component(s) associated with the power rails 184. It is envisioned that the sensors 157B may be configured to monitor current and be of a type such as, but not limited to, a Hall effect type for measuring the electromagnetic field generated by current flowing through the power rail 184, a shunt resistor current measurement type for calculating current from voltage drop measured across a resistor in the power rail 184, or any type known to one of ordinary skill in the art. As such, while the particular design, type or configuration of a sensor 157 that may be used in an embodiment of the systems and methods may be novel in, and of, itself, the systems and methods are not limited to any particular type of sensor 157. For example, even though the sensors 157B depicted in the exemplary FIG. 2 illustration are shown in association with individual power rails, it is envisioned that sensors 157A in some embodiments may be configured for measuring temperature at or near a processing component, the measurement of which may be used to deduce leakage current consumed by a given component.

A monitor module 114 may monitor and receive the signals generated by the sensor(s) 157. Notably, although the monitor module 114 and PCM module 101 are depicted in the FIG. 2 illustration as residing on the chip 102, one of ordinary skill in the art will recognize that either or both may reside off chip 102 in certain embodiments. Moreover, one of ordinary skill in the art will recognize that, in some embodiments of a PCD 100, the monitor module 114 and/or current sensors 157B may be included in the PMIC 180, although the particular embodiment illustrated in FIG. 2 depicts the monitor module 114 and current sensors 157B as independent components.

As one of ordinary skill in the art will recognize, embodiments of the PCM module 101 may include hardware and/or software interrupts handled by an interrupt service routine. That is, depending on the embodiment, a PCM module 101 may be implemented in hardware as a distinct system with control outputs, such as an interrupt controller circuit, or implemented in software, such as firmware integrated into a memory subsystem.

Returning to the FIG. 2 illustration, the monitor module 114 monitors a signal from one or more current sensors 157B to track power consumption of active components associated with the various rails. In some embodiments, the data tracked by the monitor module 114 may be continuously updated and stored in a database such that historical power consumption levels may be accessed by a PCM module 101 and used to accurately determine an available current budget for a next sub-duration of time. In addition to the current sensors 157B, monitor module 114 may also monitor temperature sensors 157A that may be associated with certain processing components and useful for determining an operating temperature. The monitor module 114 may subsequently communicate with the PCM module 101 to relay the monitored data indicative of active power consumption and operating temperature of processing components residing on the SoC 102. Advantageously, the PCM module 101 may use the monitored data to determine throttling adjustments that are directed to the DCVS module 26 for application. Through application of the throttling adjustments, the PCM module 101 may effectively optimize user experience by maintaining current consumption beneath a peak current threshold associated with the voltage regulator 189 without unnecessarily reducing power consumption.

As a non-limiting example, PCM module 101 may direct DCVS module 26 to reduce power to core 0 of CPU 110, thereby reducing overall power consumption of the SoC 102 such that a peak current threshold over a given time window is not exceeded.

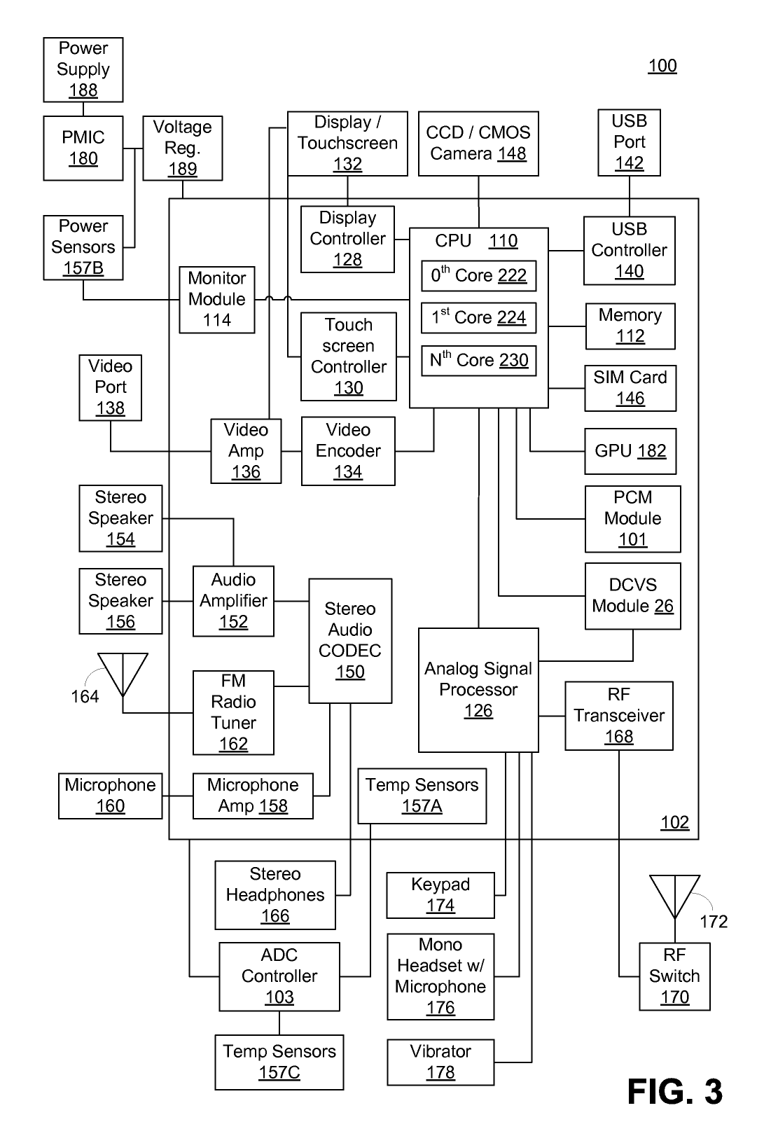

FIG. 3 is a functional block diagram of an exemplary, non-limiting aspect of a PCD 100 in the form of a wireless telephone for implementing methods and systems for peak current management. As shown, the PCD 100 includes an on-chip system 102 that includes a multi-core central processing unit (“CPU”) 110 and an analog signal processor 126 that are coupled together. The CPU 110 may comprise a zeroth core 222, a first core 224, and an Nth core 230 as understood by one of ordinary skill in the art. Further, instead of a CPU 110, a digital signal processor (“DSP”) may also be employed as understood by one of ordinary skill in the art.

In general, the peak current management (“PCM”) module 101, in conjunction with the monitor module 114, may be responsible for monitoring current consumption levels, determining available current budgets, and applying peak current management techniques to help a PCD 100 optimize its power consumption and maintain a high level of functionality. In some embodiments, the PCM module 101 may utilize a budget-based algorithm while in other embodiments it may use a PID based algorithm. Further, the PCM module 101, depending on embodiment, may consider operating temperatures of one or more processing components when determining an appropriate adjustment for maintaining current consumption beneath a peak current threshold over a certain time window.

The monitor module 114 communicates with multiple operational sensors (e.g., thermal sensors 157A and power sensors 157B) distributed throughout the on-chip system 102 and with the CPU 110 of the PCD 100 as well as with the PCM module 101. In some embodiments, monitor module 114 may also monitor power sensors 157B for current consumption rates uniquely associated with the cores 222, 224, 230 and transmit the power consumption data to the PCM module 101 and/or a database (which may reside in memory 112). The PCM module 101 may work with the monitor module 114 to determine available current budgets for upcoming sub-durations and make adjustments to power consumption levels of processing components residing on the SoC 102 such that a peak current threshold for power through the voltage regulator 189 is not violated.

As illustrated in FIG. 3, a display controller 128 and a touch screen controller 130 are coupled to the digital signal processor 110. A touch screen display 132 external to the on-chip system 102 is coupled to the display controller 128 and the touch screen controller 130. A PCM module 101 may monitor current consumption for the cores 222, 224, 230, for example, and work with the DVCS module 26 to manage power consumed by the cores. The monitor module 114 may monitor current measurements on power rails from the PMIC 180 to components of the on-chip system 102 and provide those measurements to PCM module 101 for calculation of current budgets. Advantageously, by quantifying current budgets for one or more future sub-durations, the PCM module 101 may adjust processing levels of one or more components within PCD 100 so that a peak current threshold is not exceeded.

PCD 100 may further include a video encoder 134, e.g., a phase-alternating line (“PAL”) encoder, a sequential couleur avec memoire (“SECAM”) encoder, a national television system(s) committee (“NTSC”) encoder or any other type of video encoder 134. The video encoder 134 is coupled to the multi-core central processing unit (“CPU”) 110. A video amplifier 136 is coupled to the video encoder 134 and the touch screen display 132. A video port 138 is coupled to the video amplifier 136. As depicted in FIG. 3, a universal serial bus (“USB”) controller 140 is coupled to the CPU 110. Also, a USB port 142 is coupled to the USB controller 140. A memory 112 and a subscriber identity module (SIM) card 146 may also be coupled to the CPU 110. Further, as shown in FIG. 3, a digital camera 148 may be coupled to the CPU 110. In an exemplary aspect, the digital camera 148 is a charge-coupled device (“CCD”) camera or a complementary metal-oxide semiconductor (“CMOS”) camera.

As further illustrated in FIG. 3, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 3 shows that a microphone amplifier 158 may also be coupled to the stereo audio CODEC 150. Additionally, a microphone 160 may be coupled to the microphone amplifier 158. In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 3 further indicates that a radio frequency (“RF”) transceiver 168 may be coupled to the analog signal processor 126. An RF switch 170 may be coupled to the RF transceiver 168 and an RF antenna 172. As shown in FIG. 3, a keypad 174 may be coupled to the analog signal processor 126. Also, a mono headset with a microphone 176 may be coupled to the analog signal processor 126. Further, a vibrator device 178 may be coupled to the analog signal processor 126. FIG. 3 also shows that a power supply 188, for example a battery, is coupled to the on-chip system 102 through PMIC 180. In a particular aspect, the power supply 188 includes a rechargeable DC battery or a DC power supply that is derived from an alternating current (“AC”) to DC transformer that is connected to an AC power source. Power from the PMIC 180 is provided to the chip 102 via a voltage regulator 189 with which may be associated a peak current threshold.

The CPU 110 may also be coupled to one or more internal, on-chip thermal sensors 157A as well as one or more external, off-chip thermal sensors 157C. The on-chip thermal sensors 157A may comprise one or more proportional to absolute temperature (“PTAT”) temperature sensors that are based on vertical PNP structure and are usually dedicated to complementary metal oxide semiconductor (“CMOS”) very large-scale integration (“VLSI”) circuits. The off-chip thermal sensors 157C may comprise one or more thermistors. The thermal sensors 157C may produce a voltage drop that is converted to digital signals with an analog-to-digital converter (“ADC”) controller 103. However, other types of thermal sensors 157A, 157C may be employed without departing from the scope of the invention.

The PCM module(s) 101 may comprise software which is executed by the CPU 110. However, the PCM module(s) 101 may also be formed from hardware and/or firmware without departing from the scope of the invention.

The touch screen display 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, the power supply 188, the PMIC 180 and the thermal sensors 157C are external to the on-chip system 102. However, it should be understood that the monitor module 114 may also receive one or more indications or signals from one or more of these external devices by way of the analog signal processor 126 and the CPU 110 to aid in the real time management of the resources operable on the PCD 100.

In a particular aspect, one or more of the method steps described herein may be implemented by executable instructions and parameters stored in the memory 112 that form the one or more PCM module(s) 101. These instructions that form the PCM module(s) 101 may be executed by the CPU 110, the analog signal processor 126, or another processor, in addition to the ADC controller 103 to perform the methods described herein. Further, the processors 110, 126, the memory 112, the instructions stored therein, or a combination thereof may serve as a means for performing one or more of the method steps described herein.

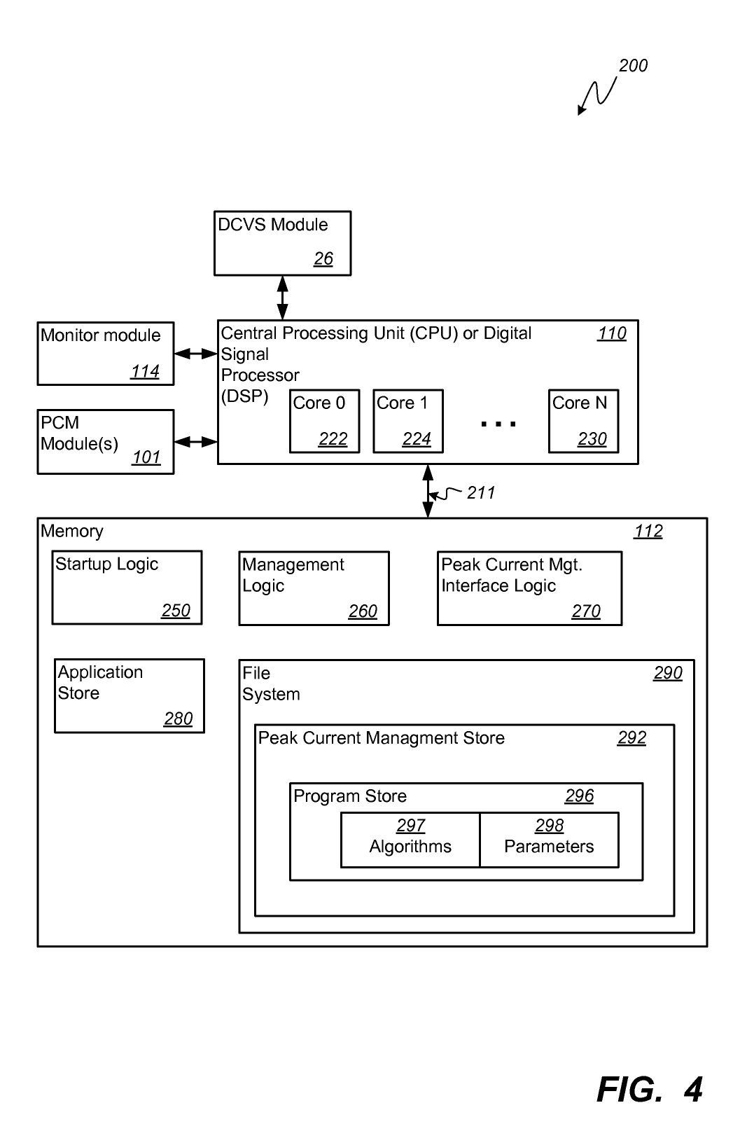

FIG. 4 is a schematic diagram illustrating an exemplary software architecture 200 of the PCD of FIG. 3 for supporting active current monitoring and application of algorithms associated with peak current management techniques. Any number of algorithms may form or be part of at least one peak current management technique that may be applied by the PCM module 101 when certain current budgets are determined and certain operating temperatures are recognized.

As illustrated in FIG. 4, the CPU or digital signal processor 110 is coupled to the memory 112 via a bus 211. The CPU 110, as noted above, is a multiple-core processor having N core processors. That is, the CPU 110 includes a first core 222, a second core 224, and an N^{th} core 230. As is known to one of ordinary skill in the art, each of the first core 222, the second core 224 and the N^{th} core 230 are available for supporting a dedicated application or program. Alternatively, one or more applications or programs may be distributed for processing across two or more of the available cores. Notably, one of ordinary skill in the art will recognize that a similar software architecture may be employed by embodiments of PCM solutions that utilize a budget-based methodology as well as embodiments that utilize a PID based methodology.

The CPU 110 may receive commands from the PCM module(s) 101 that may comprise software and/or hardware. If embodied as software, the PCM module(s) 101 comprises instructions that are executed by the CPU 110 that issues commands to other application programs being executed by the CPU 110 and other processors. For example, the PCM module(s) 101 may instruct CPU 110 to cause a certain active application program to cease so that overall current consumption by the SoC 102 is maintained beneath a peak current threshold over a certain time window.

The first core 222, the second core 224 through to the Nth core 230 of the CPU 110 may be integrated on a single integrated circuit die, or they may be integrated or coupled on separate dies in a multiple-circuit package. Designers may couple the first core 222, the second core 224 through to the N^{th} core 230 via one or more shared caches and they may implement message or instruction passing via network topologies such as bus, ring, mesh and crossbar topologies.

Bus 211 may include multiple communication paths via one or more wired or wireless connections, as is known in the art. The bus 211 may have additional elements, which are omitted for simplicity, such as controllers, buffers (caches), drivers, repeaters, and receivers, to enable communications. Further, the bus 211 may include address, control, and/or data connections to enable appropriate communications among the aforementioned components.

When the logic used by the PCD 100 is implemented in software, as is shown in FIG. 4, it should be noted that one or more of startup logic 250, management logic 260, peak current management interface logic 270, applications in application store 280 and portions of the file system 290 may be stored on any computer-readable medium for use by or in connection with any computer-related system or method.

In the context of this document, a computer-readable medium is an electronic, magnetic, optical, or other physical device or means that may contain or store a computer program and data for use by or in connection with a computer-related system or method. The various logic elements and data stores may be embodied in any computer-readable medium for use by or in connection with an instruction execution system, apparatus, or device, such as a computer-based system, processor-containing system, or other system that may fetch the instructions from the instruction execution system, apparatus, or device and execute the instructions. In the context of this document, a “computer-readable medium” may be any means that can store, communicate, propagate, or transport the program for use by or in connection with the instruction execution system, apparatus, or device.

The computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random-access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program may be electronically captured, for instance via optical scanning of the paper or other medium, then compiled, interpreted or otherwise processed in a suitable manner if necessary, and then stored in a computer memory.

In an alternative embodiment, where one or more of the startup logic 250, management logic 260 and perhaps the peak current management interface logic 270 are implemented in hardware, the various logic may be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The memory 112 is a non-volatile data storage device such as a flash memory or a solid-state memory device. Although depicted as a single device, the memory 112 may be a distributed memory device with separate data stores coupled to the digital signal processor (or additional processor cores).

In one exemplary embodiment for managing peak current consumption to optimize user experience and QoS, the startup logic 250 includes one or more executable instructions for selectively identifying, loading, and executing a select program for peak current management. A select program may be found in the program store 296 of the embedded file system 290 and is defined by a specific combination of a performance scaling algorithm 297 and a set of parameters 298. The select program, when executed by one or more of the core processors in the CPU 110, may operate in accordance with one or more signals provided by the monitor module 114 in combination with control signals provided by the one or more PCM module(s) 101 and DCVS module(s) 26 to scale or suspend the performance of the respective processor core in an effort to mitigate current consumption by the SoC 102 and guarantee that a peak current threshold is not exceeded.

The management logic 260 includes one or more executable instructions for terminating a peak current management program on one or more of the respective processor cores, as well as selectively identifying, loading, and executing a more suitable replacement program for managing or controlling the power draw of one or more of the available cores based on a calculated current budget. The management logic 260 is arranged to perform these functions at run time or while the PCD 100 is powered and in use by an operator of the device. A replacement program may be found in the program store 296 of the embedded file system 290.

The replacement program, when executed by one or more of the core processors in the digital signal processor, may operate in accordance with one or more signals provided by the monitor module 114 or one or more signals provided on the respective control inputs of the various processor cores to scale or suspend the performance of the respective processor core. In this regard, the monitor module 114 may provide one or more indicators of events, processes, applications, resource status conditions, elapsed time, temperature, current leakage, etc in response to control signals originating from the PCM module 101.

The interface logic 270 includes one or more executable instructions for presenting, managing and interacting with external inputs to observe, configure, or otherwise update information stored in the embedded file system 290. In one embodiment, the interface logic 270 may operate in conjunction with manufacturer inputs received via the USB port 142. These inputs may include one or more programs to be deleted from or added to the program store 296. Alternatively, the inputs may include edits or changes to one or more of the programs in the program store 296. Moreover, the inputs may identify one or more changes to, or entire replacements of one or both of the startup logic 250 and the management logic 260. By way of example, the inputs may include a change to the management logic 260 that instructs the PCD 100 to apply a desired throttling algorithm when the calculated current budget beneath a certain value.

The interface logic 270 enables a manufacturer to controllably configure and adjust an end user's experience under defined operating conditions on the PCD 100. When the memory 112 is a flash memory, one or more of the startup logic 250, the management logic 260, the interface logic 270, the application programs in the application store 280, data in a database or information in the embedded file system 290 may be edited, replaced, or otherwise modified. In some embodiments, the interface logic 270 may permit an end user or operator of the PCD 100 to search, locate, modify or replace the startup logic 250, the management logic 260, applications in the application store 280, data in a database and information in the embedded file system 290. The operator may use the resulting interface to make changes that will be implemented upon the next startup of the PCD 100. Alternatively, the operator may use the resulting interface to make changes that are implemented during run time.

The embedded file system 290 includes a hierarchically arranged peak current management store 292. In this regard, the file system 290 may include a reserved section of its total file system capacity for the storage of information for the configuration and management of the various parameters 298 and peak current management algorithms 297 used by the PCD 100.

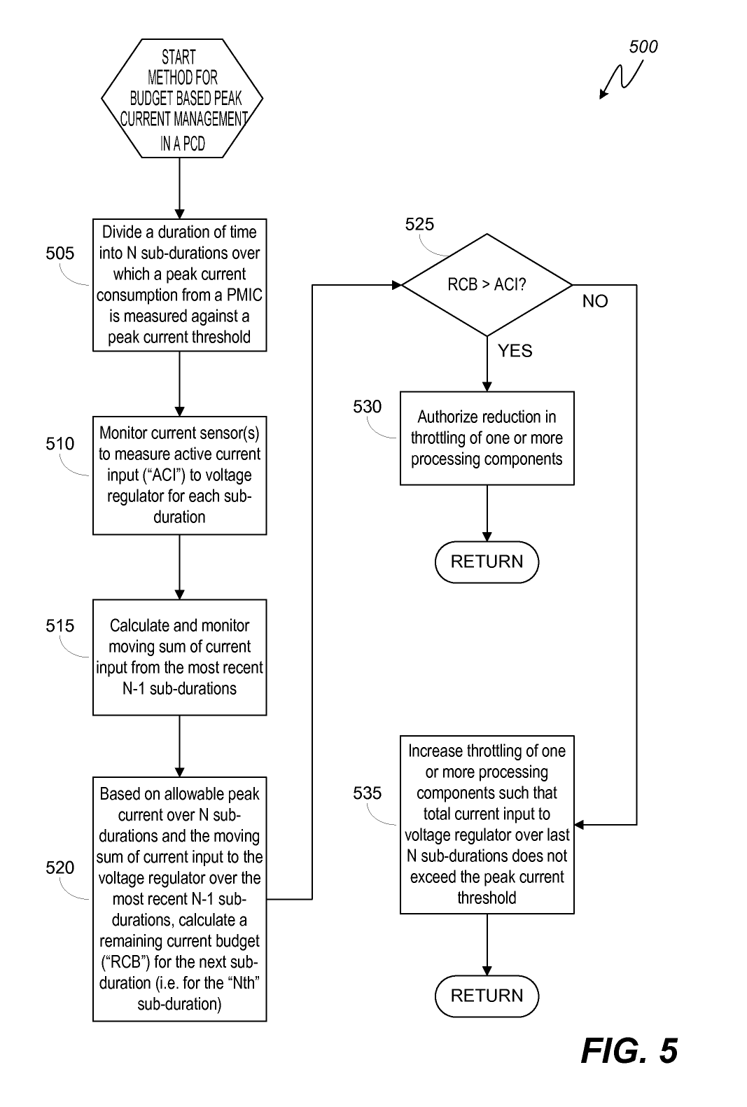

FIG. 5 is a logical flowchart illustrating a method 500 for budget-based peak current management in a PCD 100. Beginning at block 505, a duration of time over which a peak current threshold into a voltage regulator must not be exceeded is sub-divided into a number of “N” sub-durations. For example, in a system where a peak current consumption must be maintained beneath a certain peak current threshold over any given microsecond, the method 500 may view a microsecond in quarter length sub-durations (thereby setting “N” to 4). Next, at block 510 current sensor(s) may be monitored and the amount of active current input to the voltage regulator 189 measured for each sub-duration. Notably, the active current input to the voltage regulator 189 may essentially equate to the total current consumption over a period of time by processing components residing on a SoC 102 and supplied power from the PMIC 180.

At block 515, a moving sum of the active current input is calculated for the most recent (N−1) sub-durations. At block 520, a remaining current budget for the Nth sub-duration may be calculated by subtracting the sum calculated at block 515 from the maximum allowable current consumption over N sub-durations. Next, at decision block 525, the remaining current budget for the Nth sub-duration may be compared to the active current input required by the processing components for the Nth sub-duration. If the remaining current budget exceeds the required active current input, the “yes” branch is followed to block 530 and a reduction in the throttling levels to one or more processing components is authorized, i.e. the one or more processing components are authorized for an increase in power consumption such that a QoS level may be improved. If the remaining current budget is less than the required active current input, however, the “no” branch is followed to block 535 and throttling to one or more processing components is increased in an effort to maintain the total current consumption over the duration beneath a peak current threshold. The method 500 returns after blocks 530 or 535.

Notably, although the method 500 is described within the context of a peak current management technique that calculates a remaining current budget for a single next sub-duration (i.e., the “Nth” sub-duration), it is envisioned that a peak current management technique may calculate a remaining current budget for a plurality of next sub-durations. Notably, for PCM embodiments that manage a remaining current budget for more than one future sub-duration, consequences from relatively extreme di/dt events may be avoided or mitigated.

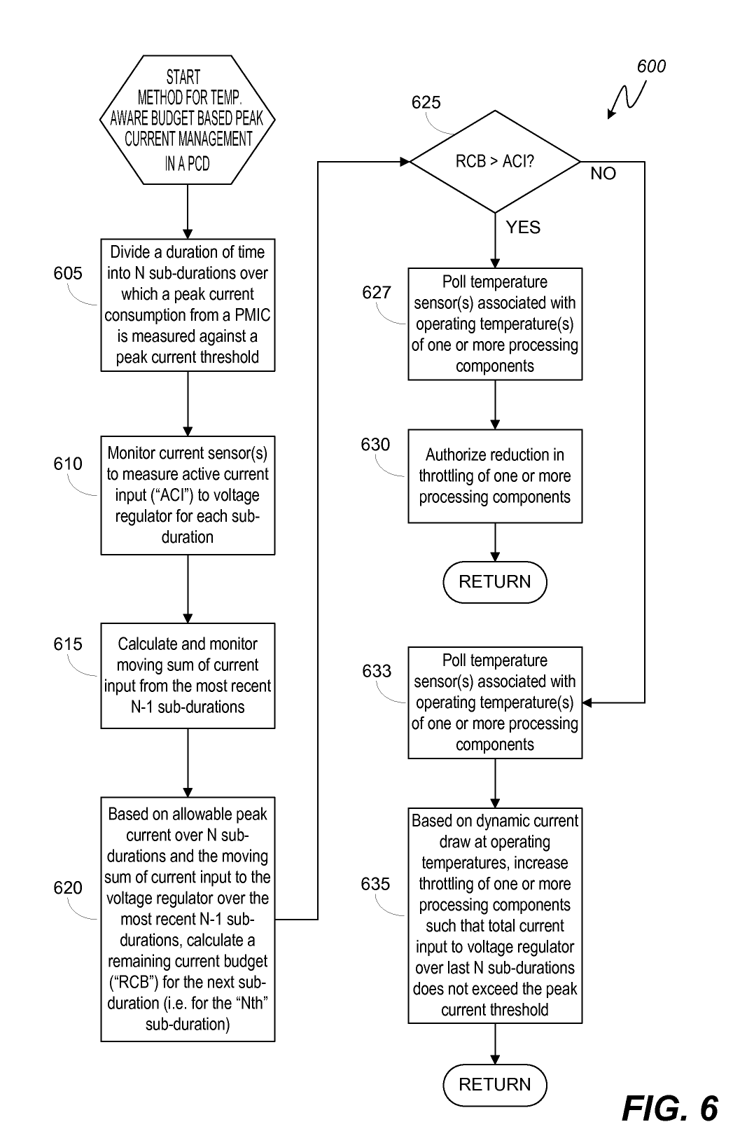

FIG. 6 is a logical flowchart illustrating a method 600 for temperature aware budget-based peak current management in a PCD 100. Beginning at block 605, a duration of time over which a peak current threshold into a voltage regulator must not be exceeded is sub-divided into a number of “N” sub-durations. For example, in a system where a peak current consumption must be maintained beneath a certain peak current threshold over any given microsecond, the method 600 may view a microsecond in quarter length sub-durations (thereby setting “N” to 4). Next, at block 610 current sensor(s) may be monitored and the amount of active current input to the voltage regulator 189 measured for each sub-duration. Notably, the active current input to the voltage regulator 189 may essentially equate to the total current consumption over a period of time by processing components residing on a SoC 102 and supplied power from the PMIC 180.

At block 615, a moving sum of the active current input is calculated for the most recent (N−1) sub-durations. At block 620, a remaining current budget for the Nth sub-duration may be calculated by subtracting the sum calculated at block 615 from the maximum allowable current consumption over N sub-durations. Next, at decision block 625, the remaining current budget for the Nth sub-duration may be compared to the active current input required by the processing components for the Nth sub-duration. If the remaining current budget exceeds the required active current input, the “yes” branch is followed to block 627 and temperature sensor(s) associated with the operating temperature(s) of one or more processing components are polled. Using the operating temperatures, the method 600 may deduce the portion of current being actively consumed by the processing component(s) that is attributable to dynamic current versus the portion that is attributable to leakage current. Subsequently, at block 630 a reduction in the throttling levels to one or more processing components is authorized, i.e. the one or more processing components are authorized for an increase in power consumption such that a QoS level may be improved. The amount of authorizes reduction in throttling may be determined based on the ratio of active dynamic current consumption to leakage current, as would be understood by one of ordinary skill in the art.

Returning to decision block 625, if the remaining current budget is less than the required active current input, the “no” branch is followed to block 633 and temperature sensor(s) associated with the operating temperature(s) of one or more processing components are polled. Using the operating temperatures, the method 600 may deduce the portion of current being actively consumed by the processing component(s) that is attributable to dynamic current versus the portion that is attributable to leakage current. Subsequently, at block 635 throttling of one or more processing components may be increased in an effort to maintain the total current consumption over the duration beneath a peak current threshold. The method 600 returns after blocks 630 or 635.

Notably, although the method 600 is described within the context of a peak current management technique that calculates a remaining current budget for a single next sub-duration (i.e., the “Nth” sub-duration), it is envisioned that a peak current management technique may calculate a remaining current budget for a plurality of next sub-durations. Notably, for PCM embodiments that manage a remaining current budget for more than one future sub-duration, consequences from relatively extreme di/dt events may be avoided or mitigated.

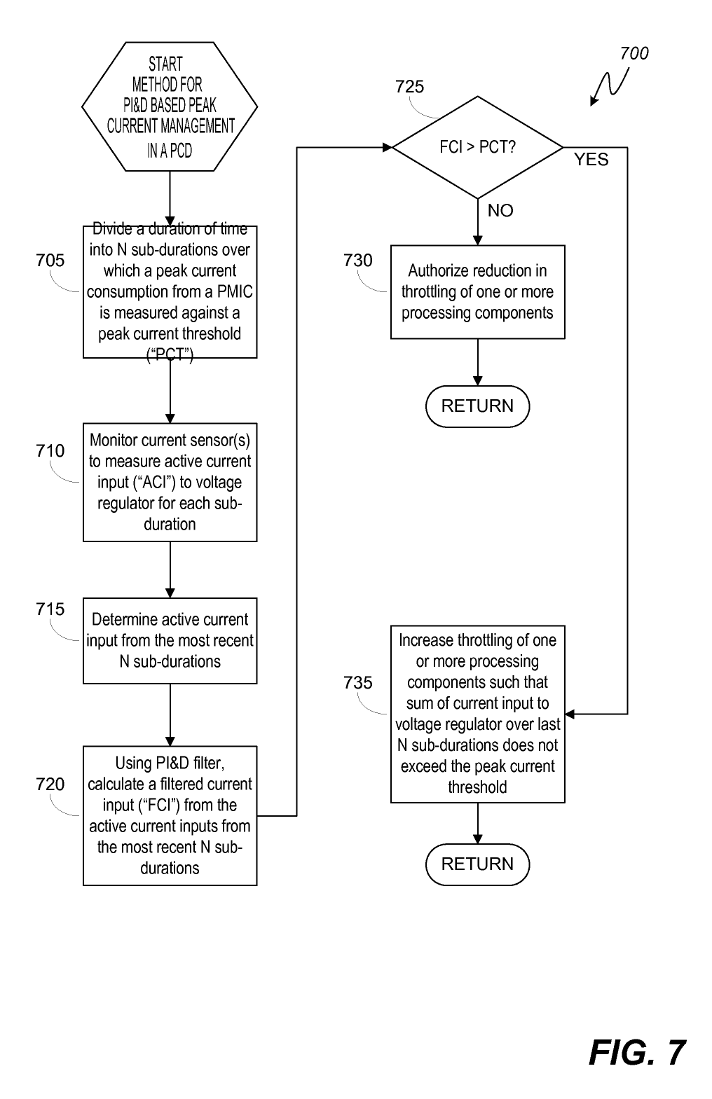

FIG. 7 is a logical flowchart illustrating a method 700 for proportional, integral and derivative (“PID”) based peak current management in a PCD 100. Beginning at block 705, a duration of time over which a peak current threshold (“PCT”) into a voltage regulator must not be exceeded is sub-divided into a number of “N” sub-durations. For example, in a system where a peak current consumption must be maintained beneath a certain peak current threshold over any given microsecond, the method 700 may view a microsecond in quarter length sub-durations (thereby setting “N” to 4). Next, at block 710 current sensor(s) may be monitored and the amount of active current input to the voltage regulator 189 measured for each sub-duration. Notably, the active current input to the voltage regulator 189 may essentially equate to the total current consumption over a period of time by processing components residing on a SoC 102 and supplied power from the PMIC 180.

At block 715, the method 700 may determine the active current input from the most recent N sub-durations and then at block 720 calculate a PID filtered current input (“FCI”) using a proportional, integral and derivative calculation as would be understood by one of ordinary skill in the art of PI&D control schemes. Next, at decision block 725 the FCI is compared to the PCT. If the FCI is less than the PCT, the “no” branch is followed to block 730 and a reduction in throttling levels for one or more processing components on the SoC 102 is authorized, thereby making available more power in an effort to improve QoS and user experience of the PCD 100. If, however, the FCI is greater than the PCT, the “yes” branch is followed to block 735 and throttling levels for one or more processing components on the SoC 102 are increased for the next sub-duration, thereby reducing the overall current consumption through the voltage regulator 189 and maintaining the peak current over the N sub-durations beneath the PCT. The method 700 returns after block 730 or block 735.

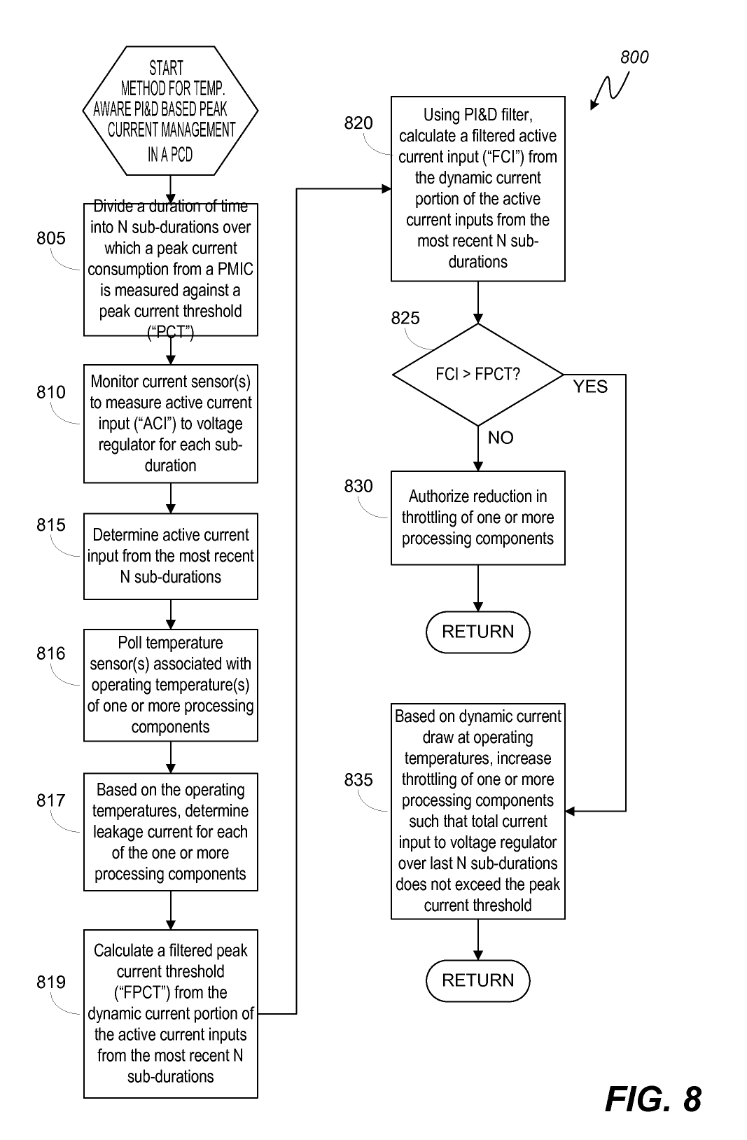

FIG. 8 is a logical flowchart illustrating a method 800 for temperature aware proportional, integral and derivative (“PID”) based peak current management in a PCD 100. Beginning at block 805, a duration of time over which a peak current threshold (“PCT”) into a voltage regulator must not be exceeded is sub-divided into a number of “N” sub-durations. For example, in a system where a peak current consumption must be maintained beneath a certain peak current threshold over any given microsecond, the method 800 may view a microsecond in quarter length sub-durations (thereby setting “N” to 4). Next, at block 810 current sensor(s) may be monitored and the amount of active current input to the voltage regulator 189 measured for each sub-duration. Notably, the active current input to the voltage regulator 189 may essentially equate to the total current consumption over a period of time by processing components residing on a SoC 102 and supplied power from the PMIC 180.

At block 815, the method 800 may determine the active current input from the most recent N sub-durations. Next, at block 816 temperature sensor(s) associated with operating temperatures of processing component(s) may be polled. Based on the operating temperature(s) of the processing component(s) that are consuming current on the SoC 102 (and thereby contributing to the current consumption through the voltage regulator 189), at block 817 a leakage current and a dynamic current for each processing component may be calculated. As one of ordinary skill in the art would understand, the leakage current consumed by a processing component may be related to the operating temperature of the processing component while the dynamic current may be attributable to the workload of the processing component.

Next, at block 819, a modified or filtered peak current threshold (“FPCT”) over the last N sub-durations may be calculated based on the dynamic current consumption of the one or more active processing components. Subsequently, at block 820 the method 800 calculates a PID filtered current input (“FCI”) based on the dynamic current consumption of the processing components and using a proportional, integral and derivative calculation as would be understood by one of ordinary skill in the art of PI&D control schemes. Next, at decision block 825 the FCI is compared to the FPCT. If the FCI is less than the FPCT, the “no” branch is followed to block 830 and a reduction in throttling levels for one or more processing components on the SoC 102 is authorized, thereby making available more power in an effort to improve QoS and user experience of the PCD 100. If, however, the FCI is greater than the FPCT, the “yes” branch is followed to block 835 and throttling levels for one or more processing components on the SoC 102 are increased for the next sub-duration based on the dynamic current consumptions, thereby reducing the overall current consumption through the voltage regulator 189 and maintaining the peak current over the N sub-durations beneath the FPCT. The method 800 returns after block 730 or block 735.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, “subsequently”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Therefore, although selected aspects have been illustrated and described in detail, it will be understood that various substitutions and alterations may be made therein without departing from the spirit and scope of the present invention, as defined by the following claims.

What is claimed is:

1. A method for managing current consumption in a portable computing device (“PCD”), the method comprising:
dividing a duration of time into a plurality of N sub-durations, wherein the duration of time is associated with a maximum allowable current consumption through a voltage regulator;
monitoring current consumption for each sub-duration;
calculating a sum of current consumption for a plurality of past sub-durations;
based on the maximum allowable current consumption and the sum of current consumption for the past sub-durations, calculating a remaining current budget; and
based on the remaining current budget, authorizing adjustments to a throttling level for a processing component.

2. The method of claim 1, wherein the remaining current budget is associated with a single next sub-duration.

3. The method of claim 1, wherein the remaining current budget is associated with a plurality of next sub-durations.

4. The method of claim 1, wherein the adjustments to a throttling level comprise reducing the throttling level.

5. The method of claim 1, wherein the adjustments to a throttling level comprise increasing the throttling level.

6. The method of claim 1, further comprising polling an operating temperature associated with the processing component, wherein the adjustments to a throttling level is based on the operating temperature.

7. The method of claim 1, wherein the adjustments to a throttling level is based on a proportional, integral and derivative calculation.

8. A computer system for managing current consumption in a portable computing device (“PCD”), the system comprising:
a peak current management (“PCM”) module operable to:
divide a duration of time into a plurality of N sub-durations, wherein the duration of time is associated with a maximum allowable current consumption through a voltage regulator;
monitor current consumption for each sub-duration;
calculate a sum of current consumption for a plurality of past sub-durations;
based on the maximum allowable current consumption and the sum of current consumption for the past sub-durations, calculate a remaining current budget; and
based on the remaining current budget, authorize adjustments to a throttling level for a processing component.

9. The computer system of claim 8, wherein the remaining current budget is associated with a single next sub-duration.

10. The computer system of claim 8, wherein the remaining current budget is associated with a plurality of next sub-durations.

11. The computer system of claim 8, wherein the adjustments to a throttling level comprise reducing the throttling level.

12. The computer system of claim 8, wherein the adjustments to a throttling level comprise increasing the throttling level.

13. The computer system of claim 8, further comprising polling an operating temperature associated with the processing component, wherein the adjustments to a throttling level is based on the operating temperature.

14. The computer system of claim 8, wherein the adjustments to a throttling level is based on a proportional, integral and derivative calculation.

15. A computer system for managing current consumption in a portable computing device (“PCD”), the system comprising:
means for dividing a duration of time into a plurality of N sub-durations, wherein the duration of time is associated with a maximum allowable current consumption through a voltage regulator;
means for monitoring current consumption for each sub-duration;
means for calculating a sum of current consumption for a plurality of past sub-durations;
means for calculating a remaining current budget based on the maximum allowable current consumption and the sum of current consumption for the past sub-durations; and
means for authorizing adjustments to a throttling level for a processing component based on the remaining current budget.

16. The computer system of claim 15, wherein the remaining current budget is associated with a single next sub-duration.

17. The computer system of claim 15, wherein the remaining current budget is associated with a plurality of next sub-durations.

18. The computer system of claim 15, wherein the adjustments to a throttling level comprise reducing the throttling level.

19. The computer system of claim 15, wherein the adjustments to a throttling level comprise increasing the throttling level.

20. The computer system of claim 15, further comprising polling an operating temperature associated with the processing component, wherein the adjustments to a throttling level is based on the operating temperature.
